(19) United States
(12) Patent Application Publication
(10) Pub. No.: US 2025/0156181 A1
(43) Pub. Date: May 15, 2025

(54) HARDWARE ACCELERATION CIRCUIT, DATA PROCESSING ACCELERATION METHOD, CHIP, AND ACCELERATOR

(71) Applicant: Guangzhou Xiaopeng Autopilot Technology Co., Ltd., Guangzhou (CN)

(72) Inventors: Jiang Jiang, Guangzhou (CN); Yuanxiang Guo, Guangzhou (CN); Weijun Zhang, Guangzhou (CN); Hengchang Xiong, Guangzhou (CN); Yu Hu, Guangzhou (CN); Chia-Lin Lu, Guangzhou (CN)

(21) Appl. No.: 18/389,444

(22) Filed: Nov. 14, 2023

(51) Int. Cl. G06F 9/30; G06F 9/38

(52) U.S. Cl. CPC G06F 9/3001; G06F 9/3877

(57) ABSTRACT

A hardware acceleration circuit, a data processing acceleration method, a chip, and an accelerator are provided. The circuit includes: an exponential function module, configured to obtain a plurality of exponential function values of a plurality of data elements in a data set; an add-subtract module, configured to obtain an addition operation result of the exponential function values; and a natural logarithm function module, configured to obtain a natural logarithm value of the addition operation result, where the add-subtract module is further configured to obtain a subtraction operation result of an i^{th} data element in the data elements and the natural logarithm value; and the exponential function module is further configured to obtain an exponential function value of the subtraction operation result, to obtain a specific function value corresponding to the i^{th} data element. Solutions provided in embodiments of this application facilitate an increase in precision of a non-linear function value.

### FIELD OF THE INVENTION

This application relates to the field of artificial intelligence technologies, and in particular, to a hardware acceleration circuit, a data processing acceleration method, a chip, and an accelerator.

### BACKGROUND OF THE INVENTION

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

Non-linear functions introduce non-linear characteristics into an artificial neural network, to play a very important role in learning and understanding a complex scenario by the artificial neural network. The non-linear functions include but are not limited to a Softmax (Softmax) function, a Sigmoid function, and the like.

The Softmax function used as an example is widely applied to deep learning. In a related technology, a function value of the Softmax function may be calculated through a general-purpose computing unit such as a central processing unit (CPU) or a graphics processing unit (GPU). However, in a case that a processing procedure of a neural network is executed by, for example, a hardware circuit such as a deep learning accelerator (Deep Learning Accelerator, DLA for short) or a neural network processing unit (Neural Network Processing Unit, NPU for short), if a Softmax function layer is located at a network intermediate layer of the neural network, overheads of job migration (job migration) between the DLA/NPU and the CPU/GPU are caused. As a result, a solution to determination of a non-linear function value by using the CPU/GPU is inefficient, resulting in an increase in system bandwidth and higher power consumption.

Therefore, a heretofore unaddressed need exists in the art to address the aforementioned deficiencies and inadequacies.

### SUMMARY OF THE INVENTION

To resolve or partially resolve the problem existing in the related technology, this application provides a hardware acceleration circuit, a data processing acceleration method, a chip, and an accelerator, to facilitate an increase in precision of an obtained non-linear function value.

A first aspect of this application provides a hardware acceleration circuit, including:
an exponential function module, configured to obtain a plurality of exponential function values of a plurality of data elements in a data set;
an add-subtract module, configured to obtain an addition operation result of the plurality of exponential function values; and
a natural logarithm function module, configured to obtain a natural logarithm value of the addition operation result, where
the add-subtract module is further configured to obtain a subtraction operation result of an i^{th} data element in the plurality of data elements and the natural logarithm value; and
the exponential function module is further configured to obtain an exponential function value of the subtraction operation result, to obtain a specific function value corresponding to the i^{th} data element.

A second aspect of this application provides an artificial intelligence chip, including the hardware acceleration circuit described above.

A third aspect of this application provides a data processing acceleration method, including:
obtaining a plurality of exponential function values of a plurality of data elements in a data set;
performing an addition operation on the plurality of exponential function values, to obtain an addition operation result;
obtaining a natural logarithm value of the addition operation result;
performing a subtraction operation on an i^{th} data element in the plurality of data elements and the natural logarithm value of the addition operation result, to obtain a subtraction operation result of subtracting the natural logarithm value from the i^{th} data element; and
obtaining an exponential function value of the subtraction operation result, to obtain a specific function value corresponding to the i^{th} data element.

A fourth aspect of this application provides an artificial intelligence accelerator, including:
a processor; and
a memory, where executable code is stored on the memory, and the executable code, when executed by the processor, enables the processor to perform the method described above.

A fifth aspect of this application provides a computer-readable storage medium, where executable code is stored on the computer-readable storage medium, and the executable code, when executed by a processor of an electronic device, enables the processor to perform the method described above.

In some embodiments of this application, a reciprocal solving procedure and a subsequent multiplication procedure of exponential function values of data elements and an addition operation result of the exponential function values of the data elements are converted, to avoid precision loss possibly caused because a reciprocal of the addition operation result approximates 0 when the addition operation result is large, thereby facilitating an increase in precision of an obtained non-linear function value.

Further, exponential function values and natural logarithm values are obtained in a table lookup manner, to avoid complex exponential operations and reciprocal operations, which can increase a data processing speed in a non-linear function calculation procedure and obtain a non-linear function value more quickly. In another aspect, excessively large hardware circuit area and excessively high costs generated for implementing exponential operations and reciprocal operations are avoided.

It should be understood that the foregoing general description and detailed description in the following are merely exemplary and interpretive, but cannot constitute a limitation to this application.

### BRIEF DESCRIPTION OF THE DRAWINGS

Through a more detailed description of exemplary implementations of this application in combination with the accompanying drawings, the above and other objectives, features and advantages of this application are more obvious. In the exemplary implementations of this application, same reference numerals generally represent same components.

FIG. 1 is a schematic structural diagram of a neural network according to an embodiment of this application;

FIG. 2 is a schematic structural diagram of a neural network for classification according to an embodiment of this application;

FIG. 3 is a structural block diagram of a hardware acceleration circuit according to an embodiment of this application;

FIG. 4 is a structural block diagram of a hardware acceleration circuit according to another embodiment of this application;

FIG. 5 is a structural block diagram of a basic lookup table circuit unit according to an embodiment of this application;

FIG. 6 to FIG. 9 are structural block diagrams of hardware acceleration circuits according to some other embodiments of this application;

FIG. 10 is a schematic flowchart of a data processing acceleration method according to an embodiment of this application;

FIG. 11 is a schematic flowchart of a data processing acceleration method according to another embodiment of this application; and

FIG. 12 is a structural block diagram of an artificial intelligence accelerator according to an embodiment of this application.

### DETAILED DESCRIPTION OF THE INVENTION

The following describes in detail implementations of this application with reference to the accompanying drawings. Although the accompanying drawings show the implementations of this application, it should be understood that this application may be implemented in various manners and is not limited by the implementations described herein. On the contrary, the implementations are provided to make this application more thorough and complete, and the scope of this application can be fully conveyed to a person skilled in the art.

The terms used in this application are for the purpose of describing specific embodiments only and are not intended to limit this application. The terms “a”, “said” and “the” of singular forms used in this application and the appended claims are also intended to include plural forms, unless otherwise specified in the context clearly. It should be further understood that the term “and/or” used herein indicates and includes any or all possible combinations of one or more associated listed items.

It should be understood that although the terms such as “first,” “second,” and “third,” may be used in this application to describe various information, the information should not be limited to these terms. These terms are merely used to distinguish between information of the same type. For example, without departing from the scope of this application, first information may also be referred to as second information, and similarly, second information may also be referred to as first information. Therefore, a feature limited by “first” or “second” may explicitly or implicitly include one or more features. In the descriptions of this application, “a plurality of” means two or more, unless otherwise definitely and specifically limited.

A calculation procedure of a non-linear function possibly relates to an operation procedure of an exponential function and/or a reciprocal. For example, an operation procedure of a Softmax function may relate to operation procedures of an exponential (exp) and a reciprocal of a sum of exponentials (1/sum_of_exp). A dedicated hardware pipeline used for the Softmax function is not feasible for implementing large-scale computing power. For example, an increase in computing power results in high hardware costs. In the related technology, a manner of obtaining a Softmax function is implemented by looking up a 16-bit integer (INT16) lookup table (LUT). However, the 16-bit LUT is a table occupying a very large storage space and includes, for example, 2∧16 (namely, 65536) entries, and a very large static random access memory (SRAM)/dynamic random access memory (DRAM) is required to store data, which results in excessively high costs of a LUT combinatorial logic circuit. In another aspect, when the 16-bit LUT is used, processing duration for completing a single time of table lookup is excessively long.

Embodiments of this application provide a hardware acceleration circuit, a chip, a data processing acceleration method, and an accelerator, where at least some logic components in a non-linear function may be implemented by using a lookup table occupying a small storage space, and power consumption, bandwidth, performance, and precision of a function value of the non-linear function can be balanced and determined, to satisfy requirements of a neural network.

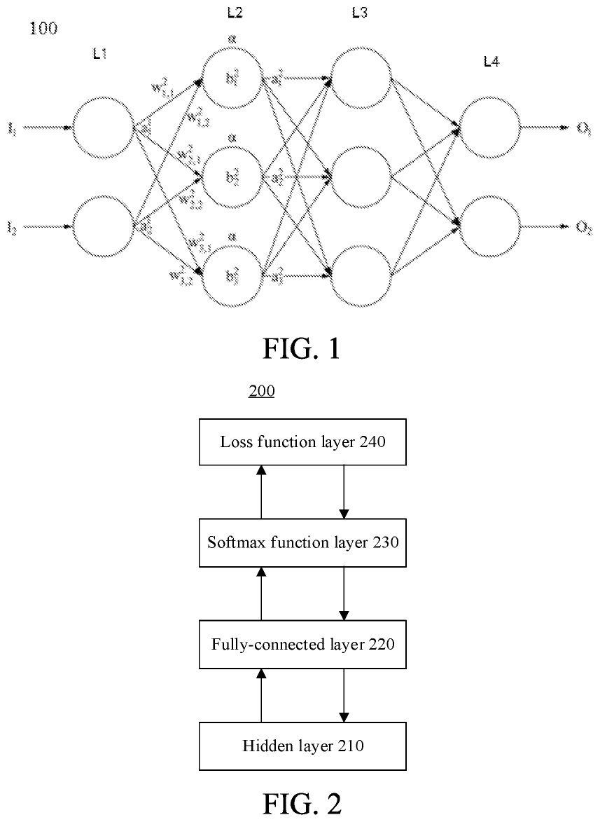

FIG. 1 is a schematic structural diagram of a neural network according to an embodiment of this application.

FIG. 1 shows a topology structure of a neural network 100, including an input layer, a hidden layer, and an output layer. The neural network 100 can execute a calculation or an operation based on data elements I₁ and I₂ received by the input layer, and generate output data O₁ and O₂ based on a result of executing the calculation.

For example, the neural network 100 may be a deep neural network (Deep Neural Networks, DNN for short) including one or more hidden layers. The neural network 100 in FIG. 1 includes an input layer L1, two hidden layers L2 and L3, and an output layer L4. The DNN includes but is not limited to a convolutional neural network (Convolutional Neural Network, CNN for short) and a recurrent neural network (Recurrent Neural Network, RNN for short).

It should be noted that the four layers shown in FIG. 1 are only intended for ease of understanding technical solutions of this application, but cannot be understood as a limitation on this application. For example, the neural network may include more or fewer hidden layers.

Nodes in different layers of the neural network 100 may be connected to each other, to perform data transmission. For example, a node may receive data from another node to execute a calculation on the received data, and output a calculation result to a node in the another layer.

Each node may determine output data of the node based on output data received from a node in a previous layer and a weight. For example, in FIG. 1, W_{1,1}² represents a weight between a first node in a first layer and a first node in a second layer. α₁¹ represents output data of the first node in the first layer. b₁² represents an offset value of the first node in the second layer, and then output data of the first node in the second layer may be represented as: α₁²=σ(W_{1,1}²×α₁¹)+b₁²). Manners of calculating output data of other nodes are similar, and details are not described herein again.

In some embodiments, an activation function layer such as a Softmax (softmax) function layer is configured in the neural network, and the Softmax function layer may convert a result value about each class to a probability value.

In some embodiments, a loss function layer is configured in the neural network after the Softmax function layer, and the loss function layer can calculate a loss as a target function for training or learning.

It may be understood that, the neural network may process, in response to to-be-processed data, the to-be-processed data, to obtain a recognition result. The to-be-processed data may include, for example, at least one of voice data, text data, and image data.

A typical type of neural network is a neural network for classification. The neural network for classification may determine a class of a data element by calculating the data element and a probability corresponding to each class.

FIG. 2 is a schematic structural diagram of a neural network for classification according to an embodiment of this application.

Referring to FIG. 2, a neural network 200 for classification of this embodiment may include a hidden layer 210, a fully-connected layer (Fully-Connected Layer, FC layer for short) 220, a Softmax function layer 230, and a loss function layer 240.

As shown in FIG. 2, the neural network 200 performs, in response to to-be-classified data, a calculation sequentially in an order of the hidden layer 210 and the FC layer 220, the FC layer 220 outputs a calculation result s, and the result corresponds to a classification probability of a data element. The FC layer 220 may include a plurality of nodes corresponding to a plurality of classes respectively, and each node outputs a result value corresponding to a probability that a data element is classified as a corresponding class. For example, referring to FIG. 1 together, the FC layer 220 corresponds to the output layer L4 in FIG. 1, and has two nodes corresponding to two classes (a first class and a second class), where an output value of one node may be a result value representing a probability that a data element is classified as the first class, and an output value of the other node may be a result value representing a probability that a data element is classified as the second class. The FC layer 220 outputs the calculation result s to the Softmax function layer 230, and the Softmax function layer 230 converts the calculation result s to a probability value y, and may further perform normalization processing on the probability value y.

The Softmax function layer 230 outputs the probability value y to the loss function layer 240, and the loss function layer 240 may calculate a cross-entropy loss (cross-entropy loss) L of the result s based on the probability value y.

In a back-propagation learning procedure, the Softmax function layer 230 calculates a gradient

$$\frac{\partial L}{\partial s}$$

of the cross-entropy loss L. Then, the FC layer 220 executes learning processing based on the gradient of the cross-entropy loss L. For example, a weight of the FC layer 220 may be updated according to a gradient descent algorithm. Further, subsequent learning processing may be executed in the hidden layer 210.

The neural network 200 may be implemented using software, or implemented using a hardware circuit, or implemented using a combination of software and hardware. For example, in a case of being implemented using a hardware circuit, the hidden layer 210, the FC layer 220, the Softmax function layer 230, and the loss function layer 240 are each implemented by a hardware circuit, and may be implemented by being integrated into an artificial intelligence chip or distributed in a plurality of chips. Through such a configuration, data migration between another layer of the neural network and a processor such as a CPU/GPU when the Softmax function layer 230 is implemented by the CPU/GPU is avoided, which can increase data processing efficiency of the neural network, reduce data processing delay and power consumption, and avoid an increase in occupied bandwidth.

The following describes in detail the technical solutions in the embodiments of this application with reference to the accompanying drawings.

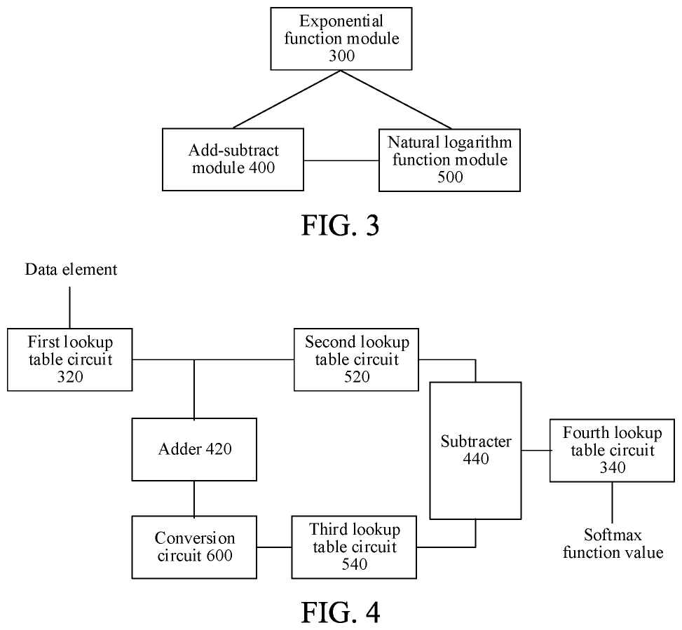

FIG. 3 is a structural block diagram of a hardware acceleration circuit according to an embodiment of this application. In this application, the hardware acceleration circuit may be, for example, configured to, but not limited to, implement the Softmax function layer 230 in the foregoing neural network 200, and the hardware acceleration circuit may be, for example, but not limited to, a circuit component in a CPLD (Complex Programmable logic device, complex programmable logic device) chip, an FPGA (Field Programmable Gate Array, field programmable gate array) chip, a dedicated chip, or the like.

For ease of understanding this application, the Softmax function is described as follows: Assuming that there is an array X, a formula of calculating a Softmax function value of an i^{th} element xᵢ may be shown as formula (1).

$$σ {( x )}_{i} = \frac{{e}^{{x}_{i}}}{{Σ}_{k} {e}^{{x}_{k}}} = \frac{{e}^{( {x}_{i} - {x}_{max} )}}{{Σ}_{k} {e}^{( {x}_{k} - {x}_{max} )}} = {e}^{( ln {e}^{( {x}_{i} - {x}_{max} )} - ln {Σ}_{k} {e}^{( {x}_{k} - {x}_{max} )} )} \qquad ( 1 )$$

$$Assuming that$$

$${y}_{i} = ln {e}^{( {x}_{i} - {x}_{max} )}$$

$$and$$

$$y = ln {Σ}_{k} {e}^{( {x}_{k} - {x}_{max} )} ,$$

$${σ ( x )}_{i} = {e}^{( {y}_{i} - y )} .$$

In the formula, σ(x); represents a Softmax function value of an i^{th} element xᵢ, e is a natural constant, xᵢ represents an i^{th} element of the array X, xₘₐₓ represents a maximum element in the array X,

$${Σ}_{k} {e}^{{x}_{k}}$$

represents an addition operation result of exponential function values of at least some elements in the array X, ln e^{x}^{ᵢ} represents a natural logarithm of an exponential function value of the i^{th} element xᵢ, and ln

$${Σ}_{k} {e}^{{x}_{k}}$$

represents a natural logarithm of an addition operation result of exponential function values of at least some elements in the array X.

Referring to FIG. 3, the hardware acceleration circuit of this embodiment includes an exponential function module 300, an add-subtract module 400, and a natural logarithm function module 500.

The exponential function module 300 is configured to output a plurality of exponential function values of a plurality of data elements in a data set.

The add-subtract module 400 is configured to perform an addition operation on the plurality of exponential function values, to output an addition operation result of the plurality of exponential function values.

The natural logarithm function module 500 is configured to obtain a natural logarithm value of the addition operation result.

The add-subtract module 400 is further configured to obtain a subtraction operation result of an i^{th} data element in the plurality of data elements and the natural logarithm value of the addition operation result.

The exponential logarithm function module 300 is further configured to obtain an exponential function value of the subtraction operation result, to obtain a specific function value corresponding to the i^{th} data element.

In some embodiments, the obtaining a subtraction operation result of an i^{th} data element and the natural logarithm value of the addition operation result includes:
obtaining an exponential function value of the i^{th} data element, then obtaining a natural logarithm value corresponding to the exponential function value, and then performing a subtraction operation on the natural logarithm value and the natural logarithm value of the addition operation result; or
performing a subtraction operation directly on the i^{th} data element and the natural logarithm value of the addition operation result.

In this embodiment, the specific function may be a non-linear function, and the non-linear function may be expressed using an exponential function. The specific function includes but is not limited to a Softmax function, a Sigmoid function, a TanH function, and the like.

It may be understood that, an addition operation result of exponential function values may be a result obtained by performing an addition operation directly on the exponential function values, or may be a result obtained by performing an addition operation on the exponential function values on which specific transformation is performed. For a situation of performing specific transformation, corresponding inverse transformation may be performed on a subsequently obtained data processing result based on a transformation type, or inverse transformation processing is not additionally performed. Similarly, various types of processing performed on other data should also be understood as including the foregoing two situations in a broad sense, but should not be limited to only processing performed on the data itself. Other embodiments are similar, and details are not described again below.

In some embodiments, the exponential function module 300 includes some or all of a first lookup table module and a fourth lookup table module. The first lookup table module is configured to output, based on the first lookup table, the plurality of exponential function values of the plurality of data elements.

In some embodiments, the natural logarithm function module 500 includes some or all of a second lookup table module and a third lookup table module. The second lookup table module is configured to output, based on a second lookup table, a natural logarithm value (also referred to as a first natural logarithm value in this application) corresponding to an exponential function value of the i^{th} data element. The third lookup table module is configured to output, based on a third lookup table, a natural logarithm value (also referred to as a second natural logarithm value in this application) corresponding to an addition operation result of the plurality of exponential function values of the plurality of data elements.

The fourth lookup table module is configured to output, based on a fourth lookup table, an exponential function value corresponding to a subtraction operation result of the first natural logarithm value and the second natural logarithm value.

In this embodiment, a reciprocal solving procedure and a subsequent multiplication procedure of exponential function values of data elements and an addition operation result of the exponential function values of the data elements are converted, to avoid precision loss possibly caused because a reciprocal of the addition operation result approximates 0 when the addition operation result is large, thereby facilitating an increase in precision of an obtained non-linear function value.

Further, exponential function values and natural logarithm values are obtained in a table lookup manner, to avoid complex exponential operations and reciprocal operations, which can increase a data processing speed in a non-linear function calculation procedure and obtain a non-linear function value more quickly. In another aspect, excessively large hardware circuit area and excessively high costs generated for implementing exponential operations and reciprocal operations are avoided.

FIG. 4 is a structural block diagram of a hardware acceleration circuit according to another embodiment of this application. Referring to FIG. 4, the hardware acceleration circuit of this embodiment includes: a first lookup table module, a second lookup table module, a third lookup table module, a fourth lookup table module, an adder 420, a conversion circuit 600, and a subtracter 440. In this embodiment, the first lookup table module, the second lookup table module, the third lookup table module, and the fourth lookup table module are implemented by independent lookup table circuits, and are also referred to as a first lookup table circuit 320, a second lookup table circuit 520, a third lookup table circuit 540, and a fourth lookup table circuit 340. It can be understood that, in some other embodiments of this application, some or all of the lookup table modules may alternatively be implemented by software modules.

The first lookup table circuit 320 is configured to output, in response to respective index values of the plurality of data elements in the data set and based on the first lookup table, the plurality of exponential function values corresponding to the plurality of data elements. An index value of a data element is data whose bit width is N0 bits.

In an embodiment, the respective index values of the plurality of data elements are sequentially input to the first lookup table circuit 320. The first lookup table circuit 320 sequentially outputs the exponential function values corresponding to the data elements in the first lookup table. Each exponential function value in the first lookup table is data whose bit width is N1 bits.

It may be understood that, an index value of data may be the data itself, or may be obtained by converting the data, and may be, for example, partial data captured from the data.

The first lookup table may be configured to implement a mapping relationship between an index value and an exponential function value of a data element. With the first lookup table, an exponential function value of a data element may be determined through a preset mapping relationship without a complex function calculation.

The adder 420 is configured to output an addition operation result of the plurality of exponential function values.

In an embodiment, the adder 420 accumulates the exponential function values of the data elements, to output an addition operation result whose bit width is N2 bits.

The conversion circuit 600 is configured to convert the addition operation result to a corresponding index value. The index value output by the conversion circuit 600 is data whose bit width is N3 bits.

In an embodiment, the conversion circuit 600 may include a leading zero count (Leading Zero Count, LZC) circuit and a shifter. The leading zero count circuit outputs a leading zero count in the addition operation result to the shifter. The leading zero count is a quantity of 0s appearing during scanning starting from the most significant bit of binary data to the first 1.

In a specific implementation, the shifter uses the leading zero count as a shifting quantity, and shifts the addition operation result to the left by the shifting quantity, to output shifted data whose bit width is N3 bits, that is, captures data of N3 consecutive bits from the addition operation result in a direction starting from the leading 1 to the least significant, to serve as an index value of the addition operation result. It may be understood that, the conversion circuit 600 may be specifically configured according to a specific data structure of an index value.

It may be understood that, in another embodiment, the leading zero count circuit may be replaced with a leading 1 detection circuit, and the leading 1 detection circuit is configured to output position data of the leading 1 in the addition operation result to the shifter, so that the shifter captures data of N3 consecutive bits from the addition operation result in a direction starting from the leading 1 to the least significant. The leading 1 is the first 1 scanned starting from the most significant bit of the binary data.

The second lookup table circuit 520 is configured to output, in response to an index value of an exponential function value of an i^{th} data element and based on a second lookup table, a natural logarithm value (namely, a first natural logarithm value) corresponding to the exponential function value of the i^{th} data element. Each first natural logarithm value stored in the second lookup table is data whose bit width is N4 bits. That is to say, the first natural logarithm value output by the second lookup table circuit 520 is data whose bit width is N4 bits.

The third lookup table circuit 540 is configured to output, in response to an index value of an addition operation result of exponential function values of data elements and based on a third lookup table, a natural logarithm value (namely, a second natural logarithm value) corresponding to the addition operation result. Each second natural logarithm value stored in the third lookup table is data whose bit width is N5 bits. That is to say, the second natural logarithm value output by the third lookup table circuit 540 is data whose bit width is N5 bits.

The subtracter 440 is configured to output a subtraction operation result of the first natural logarithm value and the second natural logarithm value. The subtraction operation result is data whose bit width is N6 bits.

The fourth lookup table circuit 340 is configured to output, in response to an index value of the subtraction operation result and based on a fourth lookup table, an exponential function value corresponding to the subtraction operation result, to obtain a Softmax function value corresponding to the i^{th} data element. The index value of the subtraction operation result is data whose bit width is N7 bits. Each exponential function value stored in the fourth lookup table is data whose bit width is N8 bits. That is to say, the exponential function value output by the fourth lookup table circuit 340 is data whose bit width is N8 bits.

In some embodiments, the first lookup table to the fourth lookup table are stored in different storage areas of a storage module respectively, and the first lookup table circuit to the fourth lookup table circuit are each configured with a basic lookup table circuit unit, and complete table lookup operations independently of each other.

In this embodiment of this application, the storage module may be, for example, a RAM (Random Access Memory, random access memory), a ROM (Read-Only Memory, read-only memory), a FLASH, or the like.

In some embodiments, data elements are subtraction operation results of pieces of initial data in an initial data set and a maximum value in the pieces of initial data, so that values of the data elements are negative values or 0. When the negative values are reduced to a specific value, a difference between exponential function values caused by a difference between the data elements may be ignored, and therefore, a value range of the data elements is limited to, for example, [−10, 0]. Because the values of the data elements are negative values or 0, exponential function values of the data elements using e as the base are normalized into a range of (0, 1], a natural logarithm value (namely, a first natural logarithm value) of an exponential function value of a data element using e as the base is limited to a range of [−13, 0], an addition operation result of the exponential function values of the data elements is limited to [1, 1024], a natural logarithm value (namely, a second natural logarithm value) of the addition operation result is in [0, 4], and a subtraction operation result of the first natural logarithm value and the second natural logarithm value is a negative value, and has an exponential function value in a range of (0, 1].

In a specific implementation, an index value of a data element is a fixed-point integer whose bit width is 8 bits. Each exponential function value in the first lookup table is data whose bit width is 8 bits. Each first natural logarithm value in the second lookup table is data whose bit width is 8 bits. The addition operation result of the plurality of exponential function values is data whose bit width is 32 bits. The index value of the addition operation result is data whose bit width is 10 bits. Each second natural logarithm value in the third lookup table is data whose bit width is 8 bits. The subtraction operation result is data whose bit width is 8 bits. Each exponential function value in the fourth lookup table is data whose bit width is 8 bits. That is to say, N0, N1, and N4 to N8 are all 8, N2 is 32, and N3 is 10. In other words, the first lookup table, the second lookup table, and the fourth lookup table are 8-bit input and 8-bit output, and the third lookup table is 10-bit input and 8-bit output.

Therefore, in this embodiment of this application, a value range of pieces of data that need to be processed in a procedure of obtain a Softmax function value may be wholly limited to a specific range, thereby making it convenient to implement the solution of this application using data with a smaller bit width and a corresponding hardware circuit. For example, when the first lookup table, the second lookup table, and the fourth lookup table are 8-bit input and 8-bit output, and the third lookup table is 10-bit input and 8-bit output, a storage space occupied by the four lookup tables requires a maximum of only 768 (3×2⁸) plus 1024 (1×2¹⁰) entries, and is significantly reduced compared with 65536 entries required by the 16-bit solution, and hardware table lookup circuits and occupied bandwidth are also correspondingly significantly reduced. In another aspect, the table lookup speed can be increased in a precision-allowed range, thereby further increasing the response speed of the circuit and reducing power consumption. The solution basically based on an 8-bit hardware circuit provided in this embodiment of this application can effectively balance important indicators of the circuit such as costs, power consumption, bandwidth, performance, and data precision.

It may be understood that, N0 to N8 may be other values, and may be, for example, values in a range of [1, 32]. In some embodiments, N0, N1, and N3 to N8 may be 9, 10, 11, or 12, namely, N0, N1, and N3 to N8 may be values in a range of [8, 12], and N0, N1, and N4 to N8 may alternatively be not equal.

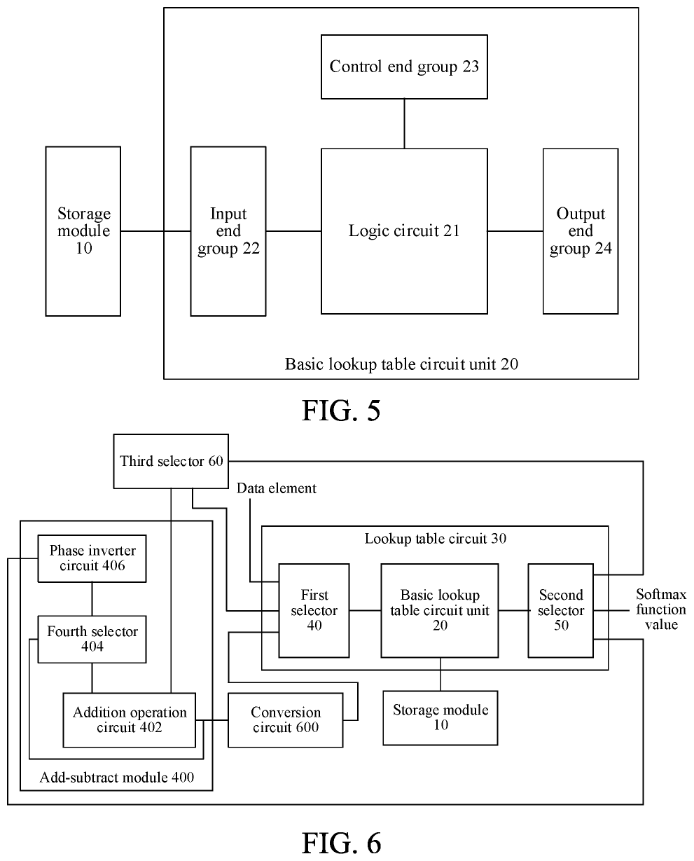

Referring to FIG. 5, in a specific implementation, a basic lookup table circuit unit includes a logic circuit 21, an input end group 22, a control end group 23, and an output end group 24. The input end group 22 inputs data of a lookup table to the logic circuit 21. The logic circuit 21 selects, through an index value (also referred to as an address) input from the control end group 23, a value corresponding to the index value from the lookup table, and outputs the value from the output end group 24. The logic circuit 21 may be, for example, a logic gate circuit or a logic switch circuit. It may be understood that, in this application, an end group refers to a group of connection ends, including one or more connection ends. In a case that the control end group 23 has A control ends and the output end group 24 has B output ends, the basic lookup table circuit unit 20 is referred to as A-input and B-output.

The basic lookup table circuit unit 20 may perform table lookup and output based on the stored lookup table. Taking a first lookup table as an example, the lookup table is also A-input and B-output, a data element of the lookup table is an index value whose bit width is A bits, and output data is an exponential function value whose bit width is B bits. It may be understood that, the first lookup table in the storage module stores only a true value of the exponential function value, and the basic lookup table circuit unit 20 is configured to implement a mapping relationship between the index value and the true value of the exponential function value.

To better understand a table lookup procedure of this embodiment of this application, Table 1 shows a specific example of the first lookup table, and the table is N0-bit input and N1-bit output, where N0 and N1 are both 8. A data element of the first lookup table may be an index value whose bit width is N0 bits, and output data may be an exponential function value whose bit width is N1 bits. For ease of understanding, each data in Table 1 is represented in a decimal format. It may be understood that, the first lookup table in the storage module stores only a true value of the exponential function value, and the lookup table circuit is configured to implement a mapping relationship between the index value and the true value of the exponential function value. To better understand this application, data elements and normalized exponential function value are listed in Table 1 together.

TABLE 1

| | | | Exponential |
|---|---|---|---|
| Index | Data | Normalized exponential | function |
| value | element | function value | value |
| 0 | 0 | 1.0 | 255 |
| 1 | −0.0390625 | 0.96169 | 246 |
| 2 | −0.078125 | 0.92485 | 237 |
| . . . | . . . | . . . | . . . |
| 254 | −0.960784 | 0.000047 | 0 |
| 255 | −10 | 0.000045 | 0 |

As shown in Table 1, data elements are negative values or 0, and a value range of the data elements is defined as [−10, 0]. To perform table lookup, the value range [−10, 0] is discretized into 256 (namely, 20) points shown by the column “data element”, an exponential function value of corresponding to each point is shown by the column “normalized exponential function value”, each data element point corresponds to an integer value in the range of [0, 255] shown in the column “index value”, each normalized exponential function value corresponds to an integer value in the range of [0, 255] shown in the column “exponential function value”, data in the column “exponential function value” is used as a true value and stored in the first lookup table of the storage module, and table lookup may be implemented through only an index value.

FIG. 6 is a structural block diagram of a hardware acceleration circuit according to another embodiment of this application. In this embodiment, a first lookup table module to a fourth lookup table module of a lookup table circuit 30 share a basic lookup table circuit unit 20, and a subtracter and an adder share an addition operation circuit 402.

Referring to FIG. 5 and FIG. 6, the hardware acceleration circuit of this embodiment includes a lookup table circuit 30, an add-subtract module 400, and a conversion circuit 600.

The lookup table circuit 30 includes the basic lookup table circuit unit 20. The basic lookup table circuit unit 20 includes a logic circuit 21, an input end group 22, a control end group 23, and an output end group 24. The input end group 22 is connected to a storage module 10, and the logic circuit 21 is configured to: output, in response to an index value of an i^{th} data element input from the control end group 23 and based on a first lookup table, an exponential function value corresponding to the i^{th} data element from the output end group 24 in a first period of time; output, in response to an index value of an exponential function value of the i^{th} data element input from the control end group 23 and based on a second lookup table, a natural logarithm value (namely, a first natural logarithm value) corresponding to the exponential function value from the output end group 24 in a second period of time after the first period of time; output, in response to an index value of an addition operation result of exponential function values of data elements input from the control end group 23 and based on a third lookup table, a natural logarithm value (namely, a second natural logarithm value) corresponding to the addition operation result from the output end group 24 in a third period of time after the first period of time; and output, in response to an index value of a subtraction operation result of the first natural logarithm value and the second natural logarithm value input from the control end group 23 and based on a fourth lookup table, an exponential function value corresponding to the subtraction operation result from the output end group 24 in a fourth period of time after the second and third periods of time.

In a specific implementation, the storage module 10 includes a first storage area, and the first lookup table to the fourth lookup table are stored in the first storage area in a time-sharing manner. Because only one storage area needs to be configured to store any one of four lookup tables in a time-sharing manner, a storage space occupied by the lookup tables is effectively reduced, and hardware costs can be reduced.

In another specific implementation, the storage module 10 includes a first storage area to a fourth storage area, and each of the first lookup table to the fourth lookup table stores one of the four storage areas.

In a specific implementation, the basic lookup table circuit unit 20 further includes a status control end group, configured to: configure, in response to a first status control signal, the basic lookup table circuit unit 20 into an M1-bit input and M2-bit output status in some of the first period of time to the fourth period of time; and configure, in response to a second status control signal, the basic lookup table circuit unit 20 into an M3-bit input and M4-bit output status in some other periods of time, where at least one of a pair of M1 and M3 and a pair of M2 and M4 is not equal. In other words, M1 and M3 are not equal, and/or M2 and M4 are not equal. This solution is applicable to a situation in which bit widths of input/output data of the first lookup table to the fourth lookup table are not completely the same.

In another specific implementation, the basic lookup table circuit unit 20 may be fixedly in an M1-bit input and M2-bit output status. This solution is applicable to a situation in which bit widths of input/output data of the first lookup table to the fourth lookup table are the same.

It may be understood that, in this embodiment, the lookup table circuit 30 further includes a first selector 40 and a second selector 50. The first selector 40 is configured to selectively output an index value of an i^{th} data element, an index value of an exponential function value of the i^{th} data element, an index value of an addition operation result of exponential function values of a plurality of data elements, and an index value of a subtraction operation result of the first natural logarithm value and the second natural logarithm value that are input through different data input channels to the control end group 23 of the basic lookup table circuit unit 20. The second selector 50 is configured to output different table lookup data output by the output end group 24 of the basic lookup table circuit unit 20 to respective corresponding data output channels.

The add-subtract module 400 is configured to obtain the addition operation result of the plurality of exponential function values before the third period of time, and obtain the subtraction operation result of the first natural logarithm value and the second natural logarithm value before the fourth period of time.

The hardware acceleration circuit of this embodiment further includes a third selector 60, configured to output the exponential function values of the data elements output by the basic lookup table circuit unit 20 to the add-subtract module 400 before the third period of time to perform accumulation processing, and input the exponential function values to the basic lookup table circuit unit 20 again, and the third selector 60 is further configured to output the first natural logarithm value output by the basic lookup table circuit unit 20 to the add-subtract module 400 before the fourth period of time to perform a subtraction operation.

In an embodiment, the add-subtract module 400 includes: an addition operation circuit 402, a fourth selector 404, and a phase inverter circuit 406.

The phase inverter circuit 406 is configured to output a negative value of the second natural logarithm value output by the lookup table circuit 30.

The fourth selector 404 is configured to input the output data of the addition operation circuit 402 to the addition operation circuit 402 recurrently before the third period of time, and input the output data of the phase inverter circuit 406 to the addition operation circuit 402 before the fourth period of time.

The addition operation circuit 402 is configured to: accumulate, before the third period of time, the exponential function values of the data elements sequentially output from the third selector 60 and the output data of the addition operation circuit 402 recurrently output by the fourth selector 404, to obtain the addition operation result of the plurality of exponential function values; and perform, before the fourth period of time, an addition operation on the first natural logarithm value output by the third selector 60 and the negative value of the second natural logarithm value output by the fourth selector 404, to obtain the subtraction operation result of the first natural logarithm value and the second natural logarithm value.

The conversion circuit 600 is configured to convert, in response to a third status control signal, the addition operation result of the plurality of exponential function values output by the add-subtract module 400 from data whose bit width is N2 bits to data whose bit width is N3 (namely, M3) bits; and convert, in response to a fourth status control signal, the subtraction operation result of the first natural logarithm value and the second natural logarithm value output by the add-subtract module from 400 data whose bit width is N2 (namely, M1) bits to data whose bit width is N7 bits, where N3 and N7 are not equal.

In this embodiment, by reusing the basic lookup table circuit unit, a table lookup requirement of four lookup table modules can be satisfied as long as one basic lookup table circuit unit is configured, so that the area and costs of the hardware acceleration circuit can be effectively reduced. The subtracter and the adder share the addition operation circuit, so that the circuit area can be further reduced. Switching of the conversion circuit between different statuses can adapt to different statuses of the basic lookup table circuit unit, making it convenient to implement table lookup with different data bit widths, thereby improving flexibility and applicability of the hardware acceleration circuit.

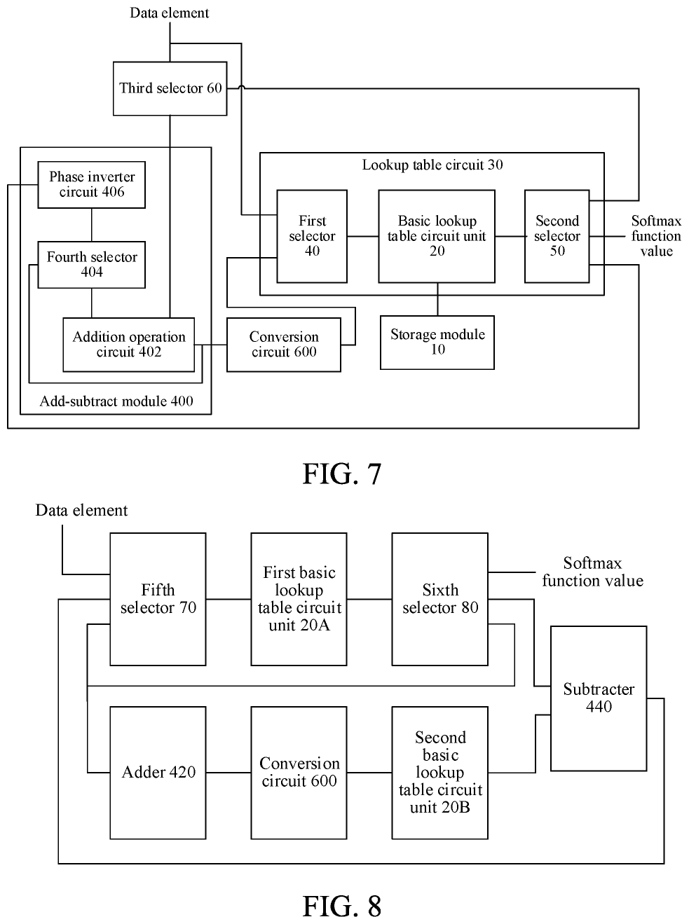

FIG. 7 is a structural block diagram of a hardware acceleration circuit according to another embodiment of this application.

For ease of understanding this embodiment, the Softmax function is first described as follows: As described above, in an array X, a formula of calculating a Softmax function value of an i^{th} element xᵢ may be shown as formula (1).

$$σ {( x )}_{i} = \frac{{e}^{{x}_{i}}}{{Σ}_{k} {e}^{{x}_{k}}} = \frac{{e}^{( {x}_{i} - {x}_{max} )}}{{Σ}_{k} {e}^{( {x}_{k} - {x}_{max} )}} = {e}^{( ln {e}^{( {x}_{i} - {x}_{max} )} - ln {Σ}_{k} {e}^{( {x}_{k} - {x}_{max} )} )} \qquad ( 1 )$$

Because a natural logarithm has the following characteristic: ln(e^{x})=x,

$$ln {e}^{( {x}_{i} - {x}_{max} )} = {x}_{i} - {x}_{max} .$$

For the above formula (1), assuming that

$${y}_{i} = ln {e}^{( {x}_{i} - {x}_{max} )} = {x}_{i} - {x}_{max} and$$

$$y = ln {Σ}_{k} {e}^{( {x}_{k} - {x}_{max} )} ,$$

$$σ {( x )}_{i} = {e}^{( ( {x}_{i} - {x}_{max} ) - ln {Σ}_{k} {e}^{( {x}_{k} - {x}_{max} )} ) =} {e}^{( {y}_{i} - y )} .$$

With reference to the above formula, in this embodiment, it is unnecessary to obtain the natural logarithm value of the exponential function value of the i^{th} data element through table lookup, namely, it is unnecessary to obtain the first natural logarithm value, but the first natural logarithm value is replaced directly with the i^{th} data element.

Referring to FIG. 5 and FIG. 7, the hardware acceleration circuit of this embodiment includes a lookup table circuit 30, an add-subtract module 400, a conversion circuit 600, and a third selector 60.

The lookup table circuit 30 includes a basic lookup table circuit unit 20, a first selector 40, and a second selector 50.

The basic lookup table circuit unit 20 includes a logic circuit 21, an input end group 22, a control end group 23, and an output end group 24. The input end group 22 is connected to a storage module 10, and the logic circuit 21 of the basic lookup table circuit unit 20 is configured to: output, in response to an index value of an i^{th} data element input from the control end group 23 and based on a first lookup table, an exponential function value corresponding to the i^{th} data element from the output end group 24 in a first period of time; output, in response to an index value of an addition operation result of exponential function values of data elements input from the control end group 23 and based on a third lookup table, a natural logarithm value (namely, a second natural logarithm value) corresponding to the addition operation result from the output end group 24 in a third period of time after the first period of time; and output, in response to an index value of a subtraction operation result of the i^{th} data element and the second natural logarithm value input from the control end group 23 and based on a fourth lookup table, an exponential function value corresponding to the subtraction operation result from the output end group 24 in a fourth period of time after the third period of time.

In a specific implementation, the storage module 10 includes a first storage area, and the first lookup table, the third lookup table, and the fourth lookup table are stored in the first storage area in a time-sharing manner. In another specific implementation, the storage module 10 includes three storage areas, and each of the first lookup table, the third lookup table, and the fourth lookup table is stored in one of the three storage areas.

The add-subtract module 400 is configured to obtain the addition operation result of the plurality of exponential function values before the third period of time, and obtain the subtraction operation result of the i^{th} data element and the second natural logarithm value before the fourth period of time.

The third selector 60 is configured to: output the exponential function values of the data elements output by the basic lookup table circuit unit 20 to the add-subtract module 400 before the third period of time to perform accumulation processing; and output the i^{th} data element to the add-subtract module 400 before the fourth period of time to perform a subtraction operation.

In an embodiment, the add-subtract module 400 includes: an addition operation circuit 402, a fourth selector 404, and a phase inverter circuit 406.

The phase inverter circuit 406 is configured to output a negative value of the second natural logarithm value output by the lookup table circuit 30.

The fourth selector 404 is configured to input the output data of the addition operation circuit 402 to the addition operation circuit 402 recurrently before the third period of time, and input the output data of the phase inverter circuit 406 to the addition operation circuit 402 before the fourth period of time.

The addition operation circuit 402 is configured to: accumulate, before the third period of time, the exponential function values of the data elements sequentially output from the third selector 60 and the output data of the addition operation circuit 402 recurrently output by the fourth selector 404, to obtain the addition operation result of the plurality of exponential function values; and perform, before the fourth period of time, an addition operation on the i^{th} data element output by the third selector 60 and the negative value of the second natural logarithm value output by the fourth selector 404, to obtain the subtraction operation result of the i^{th} data element and the second natural logarithm value.

FIG. 8 is a structural block diagram of a hardware acceleration circuit according to another embodiment of this application. The hardware acceleration circuit of this embodiment includes: a first lookup table module, a second lookup table module, a third lookup table module, a fourth lookup table module, an adder 420, a conversion circuit 600, and a subtracter 440.

Referring to FIG. 8, a difference between this embodiment and the hardware acceleration circuit in FIG. 4 lies in that, in this embodiment, the first lookup table module, the second lookup table module, and the fourth lookup table module share a first basic lookup table circuit unit 20A, and the third lookup table module is configured with a second basic lookup table circuit unit 20B; and the first basic lookup table circuit unit 20A is M1-bit input and M2-bit output, and the second basic lookup table circuit unit 20B is M3-bit input and M4-bit output, where at least one of a pair of M1 and M3 and a pair of M2 and M4 is not equal.

In this embodiment, each of the first lookup table, the second lookup table, and the fourth lookup table is M1-bit input and M2-bit output, and the third lookup table is M3-bit input and M4-bit output. In a specific example, the first lookup table, the second lookup table, and the fourth lookup table are 8-bit input and 8-bit output, and the third lookup table is 10-bit input and 8-bit output.

In a specific implementation, the first lookup table, the second lookup table, and the fourth lookup table are stored in the first storage area of the storage module in a time-sharing manner, and the third lookup table is stored in the second storage area of the storage module.

The first basic lookup table circuit unit 20A includes a first input end group, a first control end group, a first output end group, and a first logic circuit, and the first input end group is connected to the first storage area of the storage module. The first logic circuit is configured to: output, in response to index values of a plurality of data elements input from the first control end group and based on a first lookup table, exponential function values corresponding to the plurality of data elements from the first output end group in a first period of time; output, in response to an index value of an exponential function value of an i^{th} data element of the plurality of data elements input from the first control end group and based on a second lookup table, a natural logarithm value (namely, a first natural logarithm value) corresponding to the exponential function value from the first output end group in a second period of time after the first period of time; and output, in response to an index value of a subtraction operation result of the first natural logarithm value and the second natural logarithm value input from the first control end group and based on a fourth lookup table, an exponential function value corresponding to the subtraction operation result from the first output end group in a fourth period of time after the second period of time.

The second basic lookup table circuit unit 20B includes a second input end group, a second control end group, a second output end group, and a second logic circuit, and the second input end group is connected to the second storage area of the storage module. The second logic circuit is configured to: output, in response to an index value of an addition operation result of exponential function values of a plurality of data elements input from the second control end group and based on a third lookup table, a natural logarithm value (namely, a second natural logarithm value) corresponding to the addition operation result from the second output end group in a third period of time after the first period of time.

It may be understood that, in this embodiment, the hardware acceleration circuit further includes a fifth selector 70 and a sixth selector 80. The fifth selector 70 is configured to selectively output index values of a plurality of data elements, an index value of an exponential function value of an i^{th} data element of the plurality of data elements, and an index value of a subtraction operation result of the first natural logarithm value and the second natural logarithm value that are input through different data input channels to the first control end group of the first basic lookup table circuit unit 20A. The sixth selector 80 is configured to output different table lookup data output by the first output end group of the first basic lookup table circuit unit 20A to respective corresponding data output channels.

In this embodiment, by reusing one basic lookup table circuit unit for lookup table modules with the same data bit width, and configuring separate basic lookup table circuit units for lookup table modules with different data bit widths, circuit control complexity can be reduced.

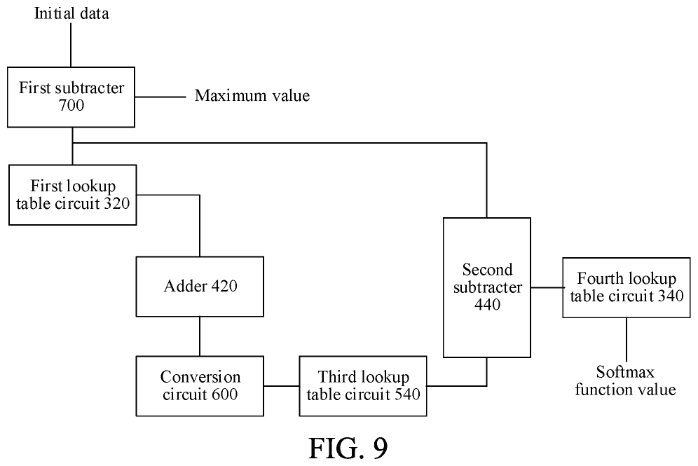

FIG. 9 is a structural block diagram of a hardware acceleration circuit according to another embodiment of this application. The hardware acceleration circuit of this embodiment includes a first lookup table module, a third lookup table module, a fourth lookup table module, an adder 420, a conversion circuit 600, a first subtracter 700, and a second subtracter 440. In this embodiment, the first lookup table module, the third lookup table module, and the fourth lookup table module are implemented by independent lookup table circuits, and are also referred to as a first lookup table circuit 320, a third lookup table circuit 540, and a fourth lookup table circuit 340.

Referring to FIG. 9, this embodiment and FIG. 4 are similar, and a main difference is as follows:

In an aspect, the hardware acceleration circuit of this embodiment is configured with a first subtracter 700. The first subtracter 700 is configured to output subtraction operation results of a plurality of pieces of initial data in an initial data set and a maximum value in the plurality of pieces of initial data, to obtain the data set including the plurality of data elements. Through the foregoing subtraction operation, a value range of the data elements can be reduced, thereby making it convenient to implement the solution of this application using data with a smaller bit width and a corresponding hardware circuit.

In another aspect, in this embodiment, the second lookup table circuit 520 in the embodiment in FIG. 4 is removed. In this embodiment, it is unnecessary to obtain the natural logarithm value of the exponential function value of the i^{th} data element through table lookup, namely, it is unnecessary to obtain the first natural logarithm value, but the first natural logarithm value is replaced directly with the i^{th} data element. Correspondingly, the exponential function value corresponding to the i^{th} data element output by the first lookup table circuit 320 needs to be input to only the adder 420.

This application further provides an embodiment of a data processing acceleration method.

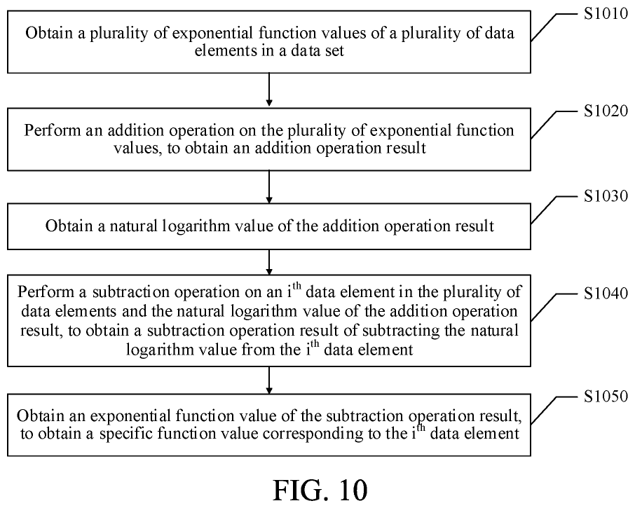

FIG. 10 is a schematic flowchart of a data processing acceleration method according to an embodiment of this application. Referring to FIG. 10, the data processing acceleration method includes:

In step S1010, a plurality of exponential function values of a plurality of data elements in a data set are obtained.

In step S1020, an addition operation is performed on the plurality of exponential function values, to obtain an addition operation result.

In step S1030, a natural logarithm value of the addition operation result is obtained.

In step S1040, a subtraction operation is performed on an i^{th} data element in the plurality of data elements and the natural logarithm value of the addition operation result, to obtain a subtraction operation result of subtracting the natural logarithm value from the i^{th} data element.

In step S1050, an exponential function value of the subtraction operation result is obtained, to obtain a specific function value corresponding to the i^{th} data element.

In some embodiments, the obtaining a plurality of exponential function values of a plurality of data elements in a data set includes: obtaining, based on a first lookup table, the plurality of exponential function values corresponding to the plurality of data elements in the data set;

In some embodiments, the obtaining a natural logarithm value of the addition operation result includes: obtaining, based on a third lookup table, the natural logarithm value corresponding to the addition operation result.

In some embodiments, the obtaining an exponential function value of the subtraction operation result includes: obtaining, based on a fourth lookup table, the exponential function value corresponding to the subtraction operation result.

In some embodiments, the performing a subtraction operation on an i^{th} data element in the plurality of data elements and the natural logarithm value of the addition operation result includes:
obtaining a natural logarithm value corresponding to an exponential function value of the i^{th} data element; and
performing a subtraction operation on the natural logarithm value corresponding to the exponential function value of the i^{th} data element and the natural logarithm value of the addition operation result.

In some embodiments, the performing a subtraction operation on an i^{th} data element in the plurality of data elements and the natural logarithm value of the addition operation result includes:
performing a subtraction operation directly on the i^{th} data element in the plurality of data elements and the natural logarithm value of the addition operation result.

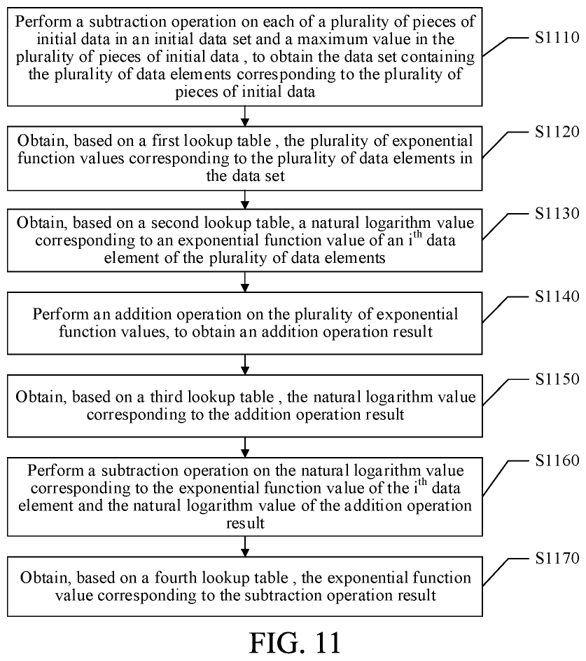

FIG. 11 is a schematic flowchart of a data processing acceleration method according to another embodiment of this application.

Referring to FIG. 11, the data processing acceleration method includes:

In step S1110, a subtraction operation is performed on each of a plurality of pieces of initial data in an initial data set and a maximum value in the plurality of pieces of initial data, to obtain the data set including the plurality of data elements corresponding to the plurality of pieces of initial data.

In step S1120, the plurality of exponential function values corresponding to the plurality of data elements in the data set are obtained based on a first lookup table.

In step S1130, a natural logarithm value corresponding to an exponential function value of an i^{th} data element of the plurality of data elements is obtained based on a second lookup table.

In step S1140, an addition operation is performed on the plurality of exponential function values, to obtain an addition operation result.

In step S1150, the natural logarithm value corresponding to the addition operation result is obtained based on a third lookup table.

In step S1160, a subtraction operation is performed on the natural logarithm value corresponding to the exponential function value of the i^{th} data element and the natural logarithm value of the addition operation result.

In step S1170, the exponential function value corresponding to the subtraction operation result is obtained based on a fourth lookup table.

In some embodiments, the first lookup table is NO-bit input and N1-bit output, the second lookup table is N1-bit input and N14-bit output, the third lookup table is N3-bit input and N5-bit output, and the fourth lookup table is N6-bit input and N7-bit output, where
values of N0, N1, and N3 to N7 are in a range of [8, 12].

In a specific implementation, the first lookup table, the second lookup table, and the fourth lookup table are 8-bit input and 8-bit output, and the third lookup table is 10-bit input and 8-bit output.

For related features of the data processing acceleration method in this embodiment of this application, reference may be made to related content in the embodiment of the foregoing hardware acceleration circuit. Details are not described again.

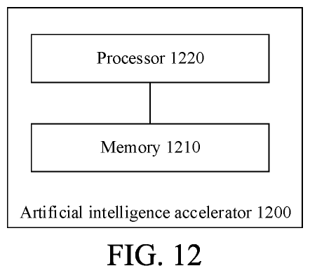

The data processing acceleration method according to this embodiment of this application may be applied to an artificial intelligence accelerator. FIG. 12 is a schematic structural diagram of an artificial intelligence accelerator according to an embodiment of this application. Referring to FIG. 12, the artificial intelligence accelerator 1200 includes a memory 1210 and a processor 1220.

The processor 1220 of the artificial intelligence accelerator 1200 may be a general-purpose processor such as a CPU (Central Processing Unit, central processing unit), or may be an intelligence processing unit (IPU) configured to execute an artificial intelligence operation. The artificial intelligence operation may include a machine learning operation, a brain-like operation, and the like. The machine learning operation includes a neural network operation, a k-means operation, a support vector machine operation, and the like. The intelligence processing unit may include, for example, one of a GPU (Graphics Processing Unit, graphics processing unit), a DLA (Deep Learning Accelerator, deep learning accelerator), an NPU (Neural-Network Processing Unit, neural network processing unit), a DSP (Digital Signal Processor, digital signal processor), a field-programmable gate array (Field-Programmable Gate Array, FPGA), and an application-specific integrated circuit (Application-Specific Integrated Circuit, ASIC) or a combination thereof. A specific type of the processor is not limited in this application.

The memory 1210 may include various types of storage units, for example, a system memory, a read-only memory (ROM), and a permanent storage apparatus. The ROM may store static data or instruction required by the processor 1220 or another module of a computer. The permanent storage apparatus may be a readable/writable storage apparatus. The permanent storage apparatus may be a non-volatile storage device that does not lose stored instructions and data even if the computer is powered off. In some implementations, a mass storage apparatus (for example, a magnetic disk, an optical disc, or a flash memory) is used as the permanent storage apparatus. In some other implementations, the permanent storage apparatus may be a removable storage device (for example, a floppy disk or an optical disc drive). The system memory may be a readable/writable storage device or a volatile readable/writable storage device, for example, a dynamic random access memory. The system memory may store some or all instructions and data required by the processor during running. Moreover, the memory 1210 may include any combination of computer-readable storage mediums, including various types of semiconductor storage chips (for example, a DRAM, an SRAM, an SDRAM, a flash memory, and a programmable read-only memory), and a magnetic disk and/or an optical disc may alternatively be used as the memory. In some implementations, the memory 1210 may include a readable and/or writable removable storage device, for example, a compact disc (CD), a read-only digital versatile disc (for example, a DVD-ROM or a double-layer DVD-ROM), a read-only Blu-ray disc, an ultra-density optical disc, a flash memory card (for example, an SD card, a min SD card, or a Micro-SD card), a magnetic floppy disk, and the like. The computer-readable storage medium does not include a carrier and an instantaneous electronic signal transmitted in a wireless or wired manner.

Executable code is stored on the memory 1210. When the executable code is processed by the processor 1220, the processor 1220 is enabled to execute part or all of the foregoing method.

In a possible implementation, the artificial intelligence accelerator may include a plurality of processors, and various assigned tasks may be independently run on each processor. The processor and the tasks run on the processor are not limited in this application.

It may be understood that, unless otherwise specified, functional units/modules in the embodiments of this application may be integrated into one unit/module, or each unit/module may exist alone physically, or two or more units/modules are integrated together. The foregoing integrated unit/module may be implemented in a form of hardware, or may be implemented in a form of a software program module.

If the integrated unit/module is implemented in a form of hardware, the hardware may be a digital circuit, an analog circuit, or the like. A physical implementation of the hardware structure includes but is not limited to a transistor, a memristor, or the like. Unless otherwise specified, the intelligence processing unit may be any proper hardware processor, for example, a CPU, a GPU, an FPGA, a DSP, or an ASIC. Unless otherwise specified, the storage module may be any proper magnetic disk storage medium or magnetic disk optical storage medium, for example, a resistive memory RRAM (Resistive Random Access Memory), a dynamic random access memory DRAM (Dynamic Random Access Memory), a static random access memory SRAM (Static Random Access Memory), an enhanced dynamic random access memory EDRAM (Enhanced Dynamic Random Access Memory), a high-bandwidth memory HBM (High-Bandwidth Memory), or a hybrid memory cube HMC (Hybrid Memory Cube).

When the integrated unit/module is implemented in the form of a software program module and sold or used as an independent product, the integrated module may be stored in a computer-readable memory. Based on such an understanding, the technical solutions of this application essentially, or the part contributing to the prior art, or all or some of the technical solutions may be implemented in a form of a software product. The computer software product is stored in a memory, and includes several instructions for instructing a computer device (which may be a personal computer, a server, or a network device) to perform all or some of the steps of the methods described in the embodiments of this application. The foregoing memory includes any medium that can store program code, such as a USB flash drive, a read-only memory (ROM, Read-Only Memory), a random access memory (RAM, Random Access Memory), a removable hard disk, a magnetic disk, or an optical disc.

In a possible implementation, an artificial intelligence chip is further disclosed, including the foregoing hardware acceleration circuit.

In a possible implementation, a card is further disclosed, including a storage device, an interface apparatus, a control device, and the foregoing artificial intelligence chip. The artificial intelligence chip is connected to each of the storage device, the control device, and the interface apparatus; the storage device is configured to store data; the interface apparatus is configured to implement data transmission between the artificial intelligence chip and an external device; and the control device is configured to monitor a status of the artificial intelligence chip.

In a possible implementation, an electronic device is disclosed, including the foregoing artificial intelligence chip. The electronic device includes a data processing apparatus, a robot, a computer, a printer, a scanner, a tablet computer, an intelligent terminal, a mobile phone, an event data recorder, a navigator, a sensor, a webcam, a server, a cloud server, a camera, a video camera, a projector, a watch, a headset, a portable storage, a wearable device, a transportation means, a household appliance, and/or a medical device. The transportation means includes an airplane, a steamship, and/or a vehicle; the household appliance includes a television set, an air conditioner, a microwave stove, a refrigerator, an electric cooker, a humidifier, a washing machine, an electric lamp, a gas stove, and a range hood; and the medical device includes a nuclear magnetic resonance spectrometer, a B-mode ultrasonic instrument, and/or an electrocardiography machine.

Moreover, the method according to this application may be further implemented as a computer program or computer program product, and the computer program or computer program product includes computer program code instructions used to execute some or all steps in the foregoing method of this application.

Alternatively, this application may be further implemented as a computer-readable storage medium (or a non-transient machine-readable storage medium or a machine-readable storage medium), on which executable code (or computer program or computer instruction code) is stored. When the executable code (or computer program or computer instruction code) is executed by a processor of an electronic device (or server or the like), the processor is enabled to execute some or all of the steps of the foregoing method according to this application.

The embodiments of this application are described above, and the foregoing descriptions are exemplary but not exhaustive and are not limited to the disclosed embodiments. Without departing from the scope and spirit of the described embodiments, many modifications and variations are apparent to a person of ordinary skill in the technical field. The selected terms used herein is intended to best explain the principles of the embodiments, practical applications, or improvements of technologies in the market, or to enable other persons of ordinary skill in the technical field to understand the embodiments disclosed herein.

What is claimed is:

1. A hardware acceleration circuit, comprising:
an exponential function module, configured to obtain a plurality of exponential function values of a plurality of data elements in a data set;
an add-subtract module, configured to obtain an addition operation result of the plurality of exponential function values; and
a natural logarithm function module, configured to obtain a natural logarithm value of the addition operation result,
wherein the add-subtract module is further configured to obtain a subtraction operation result of an i^{th} data element in the plurality of data elements and the natural logarithm value; and
wherein the exponential function module is further configured to obtain an exponential function value of the subtraction operation result in order to obtain a specific function value corresponding to the i^{th} data element.

2. The hardware acceleration circuit according to claim 1, wherein
the natural logarithm function module is further configured to obtain a natural logarithm value corresponding to an exponential function value of the i^{th} data element; and
the add-subtract module is configured to obtain the subtraction operation result of the i^{th} data element and the natural logarithm value by: obtaining a subtraction operation result of the natural logarithm value corresponding to the exponential function value of the i^{th} data element and the natural logarithm value of the addition operation result.

3. The hardware acceleration circuit according to claim 1, wherein
the exponential function module comprises at least one of a first lookup table module and a fourth lookup table module, the first lookup table module is configured to output, based on a first lookup table, the plurality of exponential function values of the plurality of data elements, and the fourth lookup table module is configured to output, based on a fourth lookup table, the exponential function value corresponding to the subtraction operation result; and
the natural logarithm function module comprises at least one of a second lookup table module and a third lookup table module, the second lookup table module is configured to output, based on a second lookup table, a natural logarithm value corresponding to an exponential function value of the i^{th} data element, and the third lookup table module is configured to output, based on a third lookup table, the natural logarithm value corresponding to the addition operation result.

4. The hardware acceleration circuit according to claim 3, comprising at least two lookup table modules of the first lookup table module to the fourth lookup table module,
wherein each of the at least two lookup table modules is configured with a basic lookup table circuit unit; or
wherein the at least two lookup table modules share a basic lookup table circuit unit.

5. The hardware acceleration circuit according to claim 3, comprising at least three lookup table modules of the first lookup table module to the fourth lookup table module,
wherein at least two of the at least three lookup table modules share a first basic lookup table circuit unit, and at least one other of the at least three lookup table modules is configured with a second basic lookup table circuit unit;
wherein the first basic lookup table circuit unit is M1-bit input and M2-bit output, and the second basic lookup table circuit unit is M3-bit input and M4-bit output; and
wherein at least one of a pair of M1 and M3 and a pair of M2 and M4 is not equal.

6. The hardware acceleration circuit according to claim 5, further comprising a conversion circuit, configured to convert, in response to a status control signal, the addition operation result of the plurality of exponential function values output by the add-subtract module from data whose bit width is N2 bits to data whose bit width is M3 bits, and output the data whose bit width is M3 bits to the second basic lookup table circuit unit; and convert, in response to another status control signal, a subtraction operation result of a first natural logarithm value and a second natural logarithm value output by the add-subtract module from data whose bit width is N2 bits to data whose bit width is M1 bits, and output the data whose bit width is M1 bits to the first basic lookup table circuit unit, wherein M1 and M3 are not equal.

7. The hardware acceleration circuit according to claim 1, wherein the add-subtract module comprises an adder and a subtracter, the adder is configured to obtain the addition operation result of the plurality of exponential function values, the subtracter is configured to obtain the subtraction operation result of the i^{th} data element and the natural logarithm value of the addition operation result,
wherein the adder and the subtracter are configured independently of each other; or
wherein the adder and the subtracter share an addition operation unit.

8. The hardware acceleration circuit according to claim 1, further comprising:
a subtracter, configured to output subtraction operation results of a plurality of pieces of initial data in an initial data set and a maximum value in the plurality of pieces of initial data in order to obtain the data set comprising the plurality of data elements.

9. The hardware acceleration circuit according to claim 3, wherein the first lookup table is NO-bit input and N1-bit output, the third lookup table is N3-bit input and N5-bit output, and the fourth lookup table is N6-bit input and N7-bit output,
wherein values of N0, N1, N3, and N5 to N7 are in a range of [8, 12].

10. An artificial intelligence chip, comprising the hardware acceleration circuit according to claim 1.

11. A data processing acceleration method, comprising:
obtaining a plurality of exponential function values of a plurality of data elements in a data set;
performing an addition operation on the plurality of exponential function values, to obtain an addition operation result;
obtaining a natural logarithm value of the addition operation result;
performing a subtraction operation on an i^{th} data element in the plurality of data elements and the natural logarithm value of the addition operation result to obtain a subtraction operation result of subtracting the natural logarithm value from the i^{th} data element; and
obtaining an exponential function value of the subtraction operation result to obtain a specific function value corresponding to the i^{th} data element.

12. The method according to claim 11, wherein
the plurality of exponential function values of the plurality of data elements in the data set are obtained by: obtaining, based on a first lookup table, the plurality of exponential function values corresponding to the plurality of data elements in the data set; and
the natural logarithm value of the addition operation result is obtained by: obtaining, based on a third lookup table, the natural logarithm value corresponding to the addition operation result; and
the exponential function value of the subtraction operation result is obtained by: obtaining, based on a fourth lookup table, the exponential function value corresponding to the subtraction operation result.

13. The method according to claim 11, wherein the subtraction operation on the i^{th} data element in the plurality of data elements and the natural logarithm value of the addition operation result is performed by:
obtaining a natural logarithm value corresponding to an exponential function value of the i^{th} data element; and
performing a subtraction operation on the natural logarithm value corresponding to the exponential function value of the i^{th} data element and the natural logarithm value of the addition operation result.

14. The method according to claim 11, wherein the subtraction operation on the i^{th} data element in the plurality of data elements and the natural logarithm value of the addition operation result is performed by:
performing a subtraction operation directly on the i^{th} data element in the plurality of data elements and the natural logarithm value of the addition operation result.

15. The method according to claim 11, wherein
the plurality of exponential function values of the plurality of data elements in the data set are obtained by: obtaining, based on a first lookup table, the plurality of exponential function values corresponding to the plurality of data elements in the data set;
the natural logarithm value of the addition operation result is obtained by: obtaining, based on a third lookup table, the natural logarithm value corresponding to the addition operation result;
the subtraction operation on the i^{th} data element in the plurality of data elements and the natural logarithm value of the addition operation result is performed by: obtaining, based on a second lookup table, a natural logarithm value corresponding to an exponential function value of the i^{th} data element; and performing a subtraction operation on the natural logarithm value corresponding to the exponential function value of the i^{th} data element and the natural logarithm value of the addition operation result; and
the exponential function value of the subtraction operation result is obtained by: obtaining, based on a fourth lookup table, the exponential function value corresponding to the subtraction operation result.

16. The method according to claim 15, wherein
the first lookup table is NO-bit input and N1-bit output, the second lookup table is N1-bit input and N14-bit output, the third lookup table is N3-bit input and N5-bit output, and the fourth lookup table is N6-bit input and N7-bit output, and
values of N0, N1, and N3 to N7 are in a range of [8, 12].

17. The method according to claim 11, further comprising:
performing a subtraction operation on each of a plurality of pieces of initial data in an initial data set and a maximum value in the plurality of pieces of initial data, to obtain the data set comprising the plurality of data elements corresponding to the plurality of pieces of initial data.

18. The method according to claim 11, being configured for implementing a Softmax function layer of a neural network, wherein the neural network is configured to classify to-be-processed data, wherein
the to-be-processed data comprises at least one of voice data, text data, and image data.

19. An artificial intelligence accelerator, comprising:
a processor; and
a memory, wherein executable code is stored on the memory, and the executable code, when executed by the processor, enables the processor to perform the method according to claim 11.
